(19) United States
(12) Patent Application Publication
(10) Pub. No.: US 2011/0026903 A1
(43) Pub. Date: Feb. 3, 2011

(54) RECORDING DEVICE

(75) Inventors: Satish K. Singh, Irving, TX (US); Anil K. Padi, Irving, TX (US)

Correspondence Address: VERIZON;PATENT MANAGEMENT GROUP, 1320 North Court House Road, 9th Floor, ARLINGTON, VA, 22201-2909, US

(73) Assignee: VERIZON PATENT AND LICENSING INC., Basking Ridge, NJ (US)

(21) Appl. No.: 12/533,225

(22) Filed: Jul. 31, 2009

(51) Int. Cl. H04N 5/91

(52) U.S. Cl. 386/297; 386/E05.001; 386/296

(57) ABSTRACT

A method includes receiving, at a recording device, an instruction or command from a user to record television programming on a first channel for a period of time. The method also includes receiving information from the user, where the information identifies one or more names or titles to associate with the programming to be recorded on the first channel for the period of time. The method further includes recording the programming on the first channel for the period of time, receiving a request to view a list of recorded programs and outputting the list of the recorded programs, where the list includes the one or more names or titles associated with the programming on the first channel for the period of time.

### BACKGROUND INFORMATION

Video recorders that interface with set top boxes to record programming have become increasingly more common. Using a conventional video recorder, a user may select a program from a program guide and record the program. In such a scenario, the user may later view a list of programs that were recorded and select one of the recorded programs for viewing.

One drawback with conventional video recorders is that the video recorder is constrained to identify the recorded programs using the information provided by the programming service provider (e.g., cable company, satellite company, etc.). That is, the video recorder identifies the recorded program according to the information listed in the programming guide provided by the programming service provider. At times, such as when multiple programs are recorded in a single block of time, the user is unaware of all of the programs that are included in that single block of time. For example, the listing associated with the recorded block of time typically identifies the recording with the name of the first program that was recorded in the block time. This may result in the user being unable to locate a recorded program of interest or inadvertently erasing the program of interest that was included in the recorded block.

### BRIEF DESCRIPTION OF THE DRAWINGS

FIG. 1 illustrates an exemplary network in which systems and methods described herein may be implemented;

FIG. 2 illustrates an exemplary configuration of the communication device of FIG. 1;

FIG. 3 illustrates an exemplary configuration of logic components implemented in the communication device of FIG. 2;

FIG. 4 is a flow diagram illustrating exemplary processing by various devices illustrated in FIG. 1; and

FIGS. 5A-5C are exemplary user interface screens provided by the logic components illustrated in FIG. 3.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein relate to allowing a user to enter customized information when recording programs using a video recorder. The customized information may then be displayed to the user when the user accesses a list of recorded programs. In one exemplary implementation, a set top box and/or digital video recorder (DVR) may include a manual recording mode in which the user may manually input a channel and time associated with a recording. The user interface provided by the set top box/video recorder may allow the user to enter a customized name or title for the recording. For example, the user may enter a name/title that he/she is more likely to associate with the recorded program. In addition, in instances where multiple programs are recorded in a continuous block of time, the user may provide multiple names/titles that will be later displayed to the user when viewing the list of recorded programs.

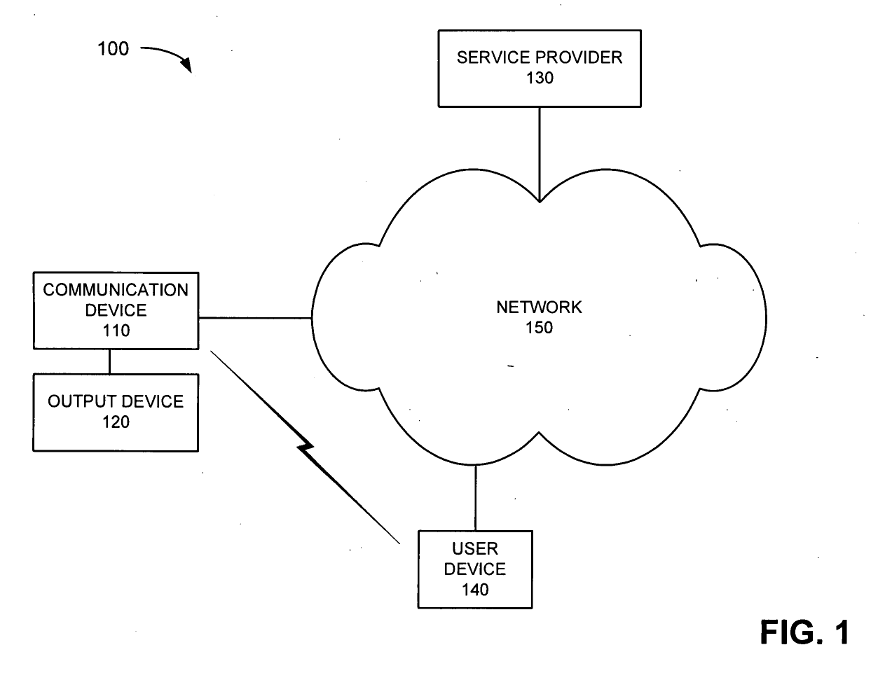

FIG. 1 is a block diagram of an exemplary network 100 in which systems and methods described herein may be implemented. Network 100 may include communication device 110, output device 120, service provider 130, user device 140 and network 150.

Communication device 110 may include any type of device that is able to receive data, such as text data, video data, image data, audio data, multi-media data, etc., transmitted from a source, such as service provider 130. Communication device 110 may decode the data and output the data to output device 120 for viewing or playing. In an exemplary implementation, communication device 110 may include a set top box used to decode incoming multi-media data, such as multi-media data received from a television service provider, a cable service provider, a satellite system, a wireless system or some other wired, wireless or optical communication medium. The term “set top box” as used herein should be construed to include any device used to receive signals from an external source and output the signals for viewing or playing. In some implementations, communication device 110 may forward the decoded data for viewing or playing by another device, such as output device 120. In other implementations, communication device 110 may play and display the decoded media.

For example, in some implementations, communication device 110 may include some type of computer, such as a personal computer (PC), laptop computer, home theater PC (HTPC), etc., that is able to receive incoming data and decode the incoming data for output to a display, which may be included with communication device 110. In this instance, communication device 110 may include logic, such as a cable card or other logic, to interface with service provider 130.

Communication device 110 may also include a digital video recorder (DVR) or any other recording device configured to record programming provided by service provider 130. The recorded programming may be available for later viewing via output device 120. In an exemplary implementation, communication device 110 may include a user interface that allows a user to customize identification or title information associated with recorded programming, as described in detail below.

Output device 120 may include any device that is able to output/display various media, such as a television, monitor, PC, laptop computer, HTPC, a personal digital assistant (PDA), a web-based appliance, a mobile terminal (e.g., a cellular telephone), etc. In an exemplary implementation, output device 120 may receive multi-media data from communication device 110 and display or play the media.

Service provider 130 may include one or more computing devices, servers and/or backend systems that are able to connect to network 150 and transmit and/or receive information via network 150. In an exemplary implementation, service provider 130 may provide multi-media information, such as television shows, movies, sporting events, podcasts or other media presentations to communication device 110 for output to a user/viewer.

User device 140 may include any device or combination of devices capable of transmitting commands to and/or receiving information from a device, such as communication device 110 or another device/system via a network, such as network 150. In one implementation, user device 140 may include a remote control device that uses infrared (IR) signals or other types of wireless signals to transmit commands and/or input information, such as information associated with recording programs, to communication device 110. Communication device 110 may receive the signals from user device 140 and perform the desired function based on the particular signal/command.

In other implementations, user device 140 may include any type of communication device, such as a plain old telephone system (POTS) telephone, a voice over Internet protocol (VoIP) telephone (e.g., a session initiation protocol (SIP) telephone), a wireless or cellular telephone device (e.g., a personal communications system (PCS) terminal that may combine a cellular radiotelephone with data processing and data communications capabilities, a PDA that can include a radiotelephone, or the like), etc. In still other implementations, user device 140 may include a PC, laptop computer or other computing device. In such implementations, user device 140 may connect to network 150 via any conventional technique, such as wired, wireless, or optical connections, to transmit commands and/or input information to communication device 110.

Network 150 may include one or more wired, wireless and/or optical networks that are capable of receiving and transmitting data, voice and/or video signals, including multi-media signals that include voice, data and video information. For example, network 150 may include one or more public switched telephone networks (PSTNs) or other type of switched network. Network 150 may also include one or more wireless networks and may include a number of transmission towers for receiving wireless signals and forwarding the wireless signals toward the intended destinations. Network 150 may further include one or more satellite networks, one or more packet switched networks, such as an Internet protocol (IP) based network, a local area network (LAN), a wide area network (WAN), a personal area network (PAN) (e.g., a wireless PAN), an intranet, the Internet, or another type of network that is capable of transmitting data.

The exemplary configuration illustrated in FIG. 1 is provided for simplicity. It should be understood that a typical network may include more or fewer devices than illustrated in FIG. 1. For example, network 100 may include additional elements, such as switches, gateways, routers, backend systems, etc., that aid in routing information, such as media streams from service provider 130 to communication device 110. In addition, although communication device 110, output device 120 and user device 140 are shown as separate devices in FIG. 1, in other implementations, the functions performed by two or more of these devices may be performed by a single device or platform. Alternatively, in other implementations, a recording device associated with recording programming from service provider 130 may be located externally with respect to communication device 110.

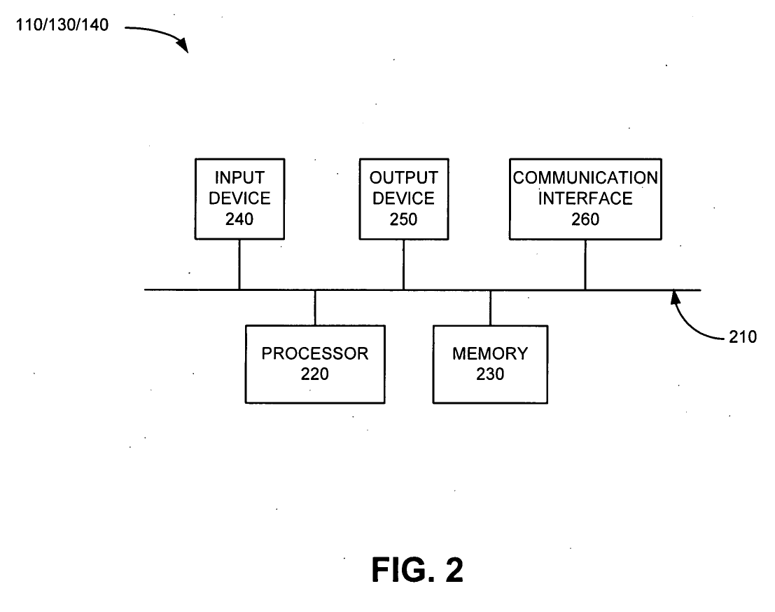

FIG. 2 illustrates an exemplary configuration of communication device 110. Service provider 130 and user device 140 may be configured in a similar manner. Referring to FIG. 2, communication device 110 may include a bus 210, a processor 220, a memory 230, an input device 240, an output device 250 and a communication interface 260. Bus 210 may include a path that permits communication among the elements of communication device 110.

Processor 220 may include one or more processors, microprocessors, or processing logic that may interpret and execute instructions. Memory 230 may include a random access memory (RAM) or another type of dynamic storage device that may store information and instructions for execution by processor 220. Memory 230 may also include a read only memory (ROM) device or another type of static storage device that may store static information and instructions for use by processor 220. Memory 230 may further include a solid state drive (SDD). Memory 230 may also include a magnetic and/or optical recording medium (e.g., a hard disk) and its corresponding drive. In an exemplary implementation, memory 230 may store programming received from service provider 130, as described in detail below.

Input device 240 may include a mechanism that permits a user to input information to communication device 110, such as a keyboard, a keypad, a mouse, a pen, a microphone, a touch screen, voice recognition and/or biometric mechanisms, etc. Input device 240 may also include mechanisms for receiving input via a remote control device, such as user device 140, which may be a device that sends commands to communication device 110 via IR or radio frequency signals. Output device 250 may include a mechanism that outputs information to the user, including a display, a printer, a speaker, etc.

Communication interface 260 may include any transceiver-like mechanism that communication device 110 may use to communicate with other devices (e.g., output device 120 (FIG. 1) and user device 140) and/or service provider 130. For example, communication interface 260 may include mechanisms for communicating with output device 120, service provider 130 and/or user device 140 via wired, wireless or optical mechanisms. For example, communication interface 260 may output received programming to output device 120. Communication interface 260 may also include one or more radio frequency (RF) transmitters, receivers and/or transceivers and one or more antennas for transmitting and receiving RF data via network 150. Communication interface 260 may further include a wireless interface for communicating with other devices in network 100, such as user device 140. Communication interface 260 may also include a modem or an Ethernet interface to a LAN or other mechanisms for communicating via a network, such as network 150 or another network via which communication device 110 communicates with other devices/systems.

The exemplary configuration illustrated in FIG. 2 is provided for simplicity. It should be understood that communication device 110, service provider 130 and/or user device 140 may include more or fewer devices than illustrated in FIG. 2. For example, various modulating, demodulating, coding and/or decoding components, one or more power supplies or other components may be included in one or more of communication device 110, service provider 130 and user device 140.

Communication device 110 may perform processing associated with interacting with output device 120, user device 140 and other devices in network 100. For example, communication device 110 may perform processing associated with receiving commands and information from a user via, for example, user device 140. The information provided by the user may include instructions for recording programming provided by service provider 130. The information provided by the user may also include customized names associated with the programs to be recorded. Communication device 110 may perform these operations in response to processor 220 executing sequences of instructions contained in a computer-readable medium, such as memory 230. A computer-readable medium may be defined as a physical or logical memory device. The software instructions may be read into memory 230 from another computer-readable medium (e.g., a hard disk drive (HDD), SSD, etc.), or from another device via communication interface 260. Alternatively, hard-wired circuitry may be used in place of or in combination with software instructions to implement processes consistent with the implementations described herein. Thus, implementations described herein are not limited to any specific combination of hardware circuitry and software.

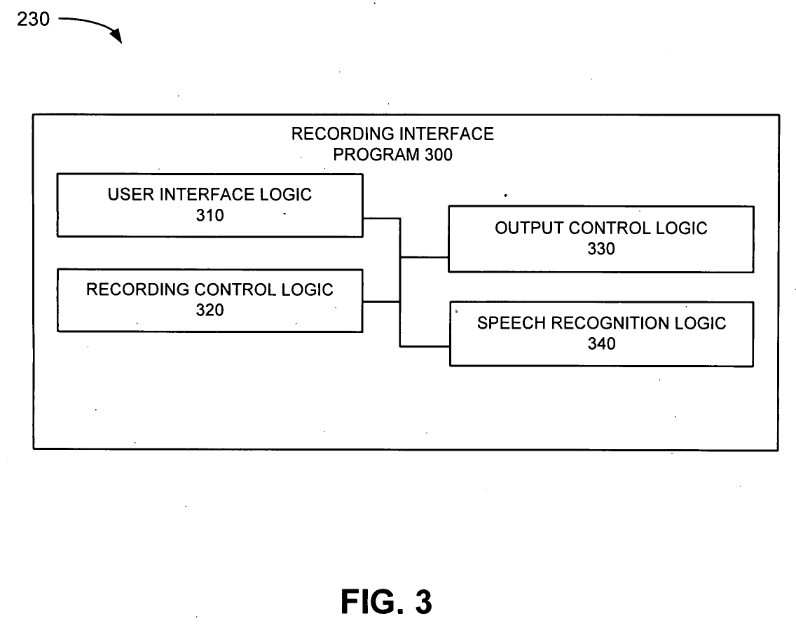

FIG. 3 is an exemplary functional block diagram of components implemented in communication device 110 of FIG. 2. In an exemplary implementation, all or some of the components illustrated in FIG. 3 may be stored in memory 230. For example, referring to FIG. 3, memory 230 may include recording interface program 300.

Recording interface program 300 may include a software program executed by processor 220 that allows communication device 110 to communicate with wired and wireless devices, such as user device 140. In an exemplary implementation, recording interface program 300 may include user interface logic 310, recording control logic 320, output control logic 330 and speech recognition logic 340. Recording interface program 300 and its various logic components are shown in FIG. 3 as being included in communication device 110. In alternative implementations, these components or a portion of these components may be located externally with respect to communication device 110. For example, in some implementations, one or more of the components of recording interface program 300 may be located in or executed by output device 120 or located in a device external to communication device 110, such as an external recording device. In still other implementations, one or more of the components illustrated in FIG. 3 may be located at service provider 130.

User interface logic 310 may include logic to provide a user with an interface to enter information associated with recording programs provided by service provider 130. For example, user interface logic 310 may provide a graphical user interface (GUI) that allows a user to easily enter information identifying programs to record. The GUI provided by user interface logic 310 may also allow a user to input user-defined names associated with the programming that is to be recorded. Using user-defined or customized names may allow a user to more easily review a recorded playlist at a later time. For example, user interface logic 310 may display recorded playlists with the user-defined names and/or other user-related information, as described in detail below.

Recording control logic 320 may include logic for recording programming provided by service provider 130 based on user-defined information. For example, recording control logic 320 may record programs identified by the user via user interface logic 310.

Output control logic 330 may include logic to output programming (e.g., television shows) stored by communication device 110. For example, output control logic 330 may output programming stored on communication device 110 to output device 120 based on user commands provided via user interface logic 310.

Speech recognition logic 340 may include logic to perform speech recognition on voice data provided by one or more parties. For example, speech recognition logic 340 may convert voice data received from a party associated with user device 140 into a command corresponding to the voice data. In some implementations, speech recognition logic 340 may be designed to identify particular terms/phrases that may be associated with recording television programs, such as “record channel X at eight o'clock,” where X may be any number. Speech recognition logic 340 may also be designed to identify particular terms/phrases that may be associated with naming programs to be recorded by communication device 110, such as “Joe's favorite show,” “sports highlights,” “do not erase,” etc. In an exemplary implementation, speech recognition logic 340 may include a voice over extensible markup language (VOXML) application that converts voice input into corresponding text data.

Communication device 110, as described above, may receive programming from service provider 130 for display via output device 120. Communication device 110 may also interact with users to perform various functions associated with recording programming and allowing a user to associate customized names with the recorded programs, as described in detail below.

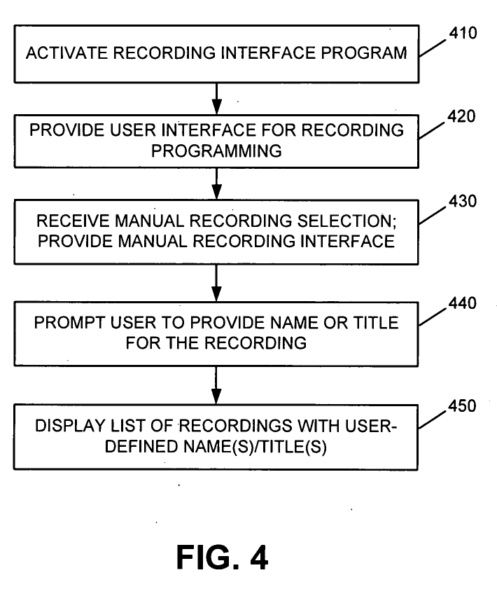

FIG. 4 is a flow diagram illustrating exemplary processing associated with a user interacting with communication device 110 to record programs. In this example, assume that user device 140 is a remote control device associated with controlling communication device 110 and/or output device 120. Processing may begin with a user of user device 140 coming into relatively close proximity with communication device 110. For example, assume that a user of user device 140 is watching television provided on output device 120 and wants to record a program. Further assume that user device 140 includes a “DVR” button or similar button that activates recording interface program 300.

The user of user device 140 may press the DVR button and communication device 110 may receive the command associated with the DVR button. In response to receiving the DVR input/command from user device 140, communication device 110 may launch or activate recording interface program 300 (act 410). User interface logic 310 of recording interface program 300 may provide a user interface associated with recording programming via communication device 110 (act 420).

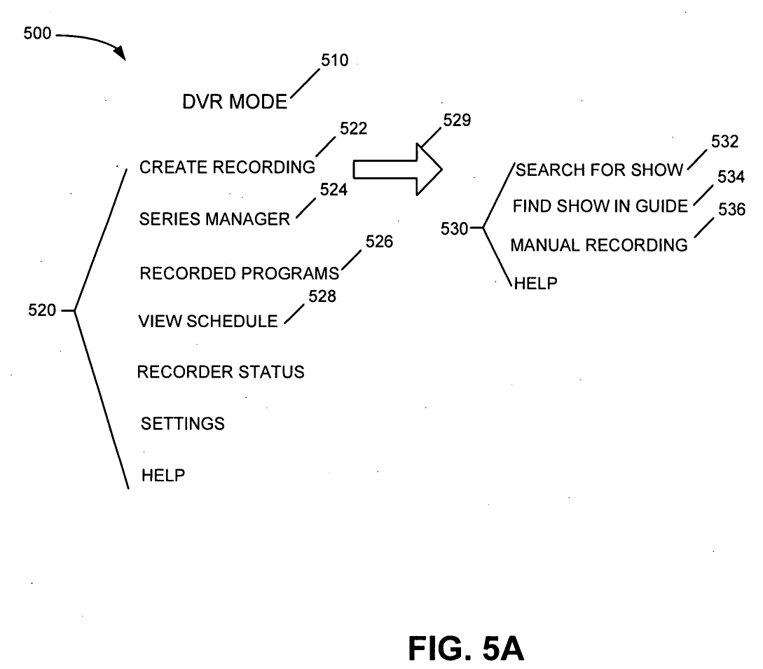

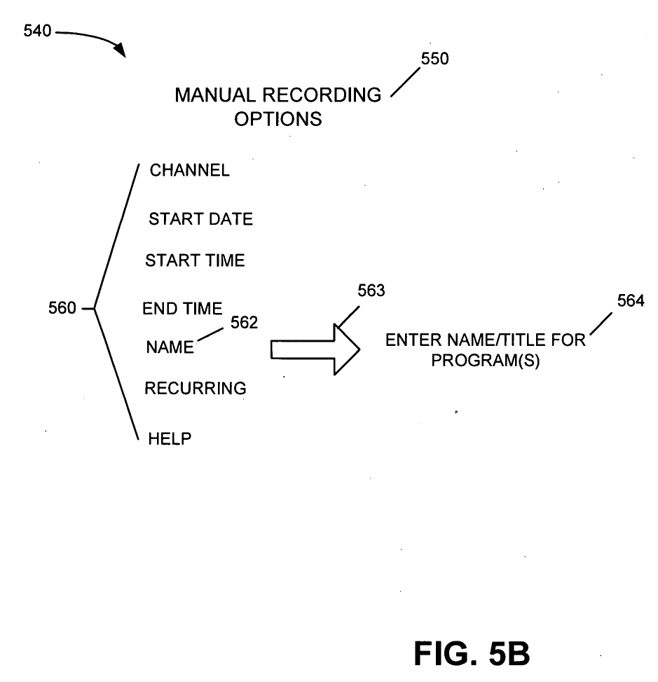

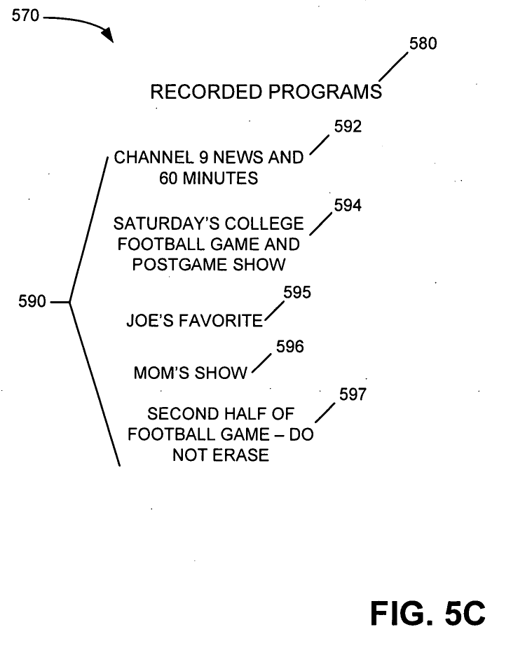

For example, user interface logic 310 may output GUI 500 illustrated in FIG. 5A to output device 120, in response to receipt of the DVR input. Referring to FIG. 5A, GUI 500 may include title 510 indicating that communication device 110 is in the DVR mode and a menu 520 listing options associated with recording programs. In an exemplary implementation, menu 520 may include the following items: create recording item 522, series manager item 524, recorded programs item 526, view schedule item 528, recorder status item, settings item and help item. The items illustrated in menu 520 are exemplary and it should be understood that menu 520 may include other items and/or different items associated with recording programs.

Assume that the user would like to create a recording. In this case, the user may select create recording item 522 via user device 140. For example, the user may use navigational keys/buttons on user device 140 to highlight item 522 and select item 522 by pressing an “OK” button or similar button.

User interface logic 310 may receive the selection from user device 140, as indicated by arrow 529 in FIG. 5A, and provide menu 530 in response to the selection. Menu 530 may include the following items: search for show item 532, find show in guide item 534, manual recording item 536 and help item. Similar to menu 520, the items illustrated in menu 530 are exemplary and it should be understood that menu 530 may include other items and/or different items associated with creating a recording.

Manual recording item 536 may correspond to a user creating a recording that may not be associated with recording a particular program on a regular basis. Recording programs, such as television series on a weekly basis, may be handled by selecting series manager item 524 in menu 520.

Returning to FIG. 4, assume that the user selects manual recording item 536 via user device 140. User interface logic 310 may receive the manual recording selection and output an interface to output device 120 that facilitates entry of information associated with recording a program (act 430). For example, user interface logic 310 may provide GUI 540 illustrated in FIG. 5B to output device 120. Referring to FIG. 5B, GUI 540 may include title 550 and menu 560. Title 550 may indicate that communication device 110 is in the manual recording options mode. Menu 560 may include the following items or options associated with recording a program: channel item, start date item, start time item, end time item, name item 562, recurring item and help item.

The user may provide input for menu items 560 via user device 140. For example, the user may select the appropriate channel, start date, start time and end time for the program to be recorded. The user may also select name item 562. In response to selection of name item 562, user interface logic 310 may prompt the user to create a name for the program that is to be recorded (act 440). For example, upon selection of item 562 (indicated by the arrow 563 in FIG. 5B), user interface logic 310 may prompt the user to enter a name, title or other identifier associated with the program that is to be recorded, as illustrated by item 564 in FIG. 5B. This user-supplied name/title may allow the user to input the names of several television programs that are to be recorded as a single block of time. For example, suppose that the user wishes to record Channel 9 from 6:00PM to 8:00PM, which includes three programs (e.g., the local news, the national news and the television show 60 Minutes). In this case, the user may input “local news, national news, 60 Minutes” in response to the prompt by user interface logic 310 at item 564.

The user may input the names/titles via user device 140. For example, in some implementations, user device 140 may include a keyboard or keypad that allows the user to input alphanumeric characters. In other implementations, user interface logic 310 may output a keypad on output device 120 that allows the user to select and input alphanumeric characters. In either case, the user may enter his/her user-defined names for a block of television programming. This is in contrast to conventional recorders that do not allow the user to name the television program that is to be recorded, much less name several television programs that are recorded in a single block of time.

The user-supplied names/title of programs to be recorded may also allow the user to include information more likely to be remembered by the user, such as “Joe's favorite, ” “Mom's show,” etc. In each case, the user may supply the name(s) or title(s) of one or more programs that are to be recorded by communication device 110.

Now assume that the user wishes to view a list of programs recorded by communication device 110. In this case, the user may select recorded programs item 526 in GUI 500 (FIG. 5A). User interface logic 310 may receive the selection and output a list of recorded programs with the user-supplied names/titles (act 450). For example, user interface logic 310 may output GUI 570, illustrated in FIG. 5C. Referring to FIG. 5C, GUI 570 may include title 580 and menu 590. Title 580 may identify that communication device 110 is in a mode associated with listing previously recorded programs. Menu 590 (also referred to as listing 590) may list the currently recorded programs. As discussed above, user interface logic 310 may allow a user to identify or associate one or more names with programming that is to be recorded. For example, referring to FIG. 5C, item 592 may identify two programs (i.e., Channel 9 News and 60 Minutes) that were recorded on the same channel in a continuous block of time. This may allow the user to more quickly identify what is actually stored on communication device 110. Similarly, item 594 may list two programs that were recorded from the same channel in a continuous block of time (i.e., Saturday's College Football Game and Postgame Show).

As described above, the user-defined names may also provide the user with other information that may be particularly relevant to the user. For example, item 595 may be “Joe's favorite.” Such a name may be particularly relevant to Joe to allow Joe to quickly find a program of interest. Similarly, item 596 may be “Mom's show,” which may allow a mother or other family member to quickly identify who has recorded the program.

Still further, entry 597 may be “Second Half of Football Game—Do Not Erase.” Providing such a name, with the additional information indicating that the program should not be erased, allows a user to provide messages or other supplemental information associated with a displayed title. This may allow other parties to avoid inadvertently erasing an important program. In each case, menu 590 may provide a listing of recorded programs that are identified by user-defined names, as opposed to using information provided in a programming guide provided by service provider 130. In addition, multiple programs stored in a continuous block of time on the same channel may be separately identified in listing 590. In this manner, users may quickly identify recorded programs of interest and may be less likely to inadvertently erase a program of interest.

In an exemplary implementation, user interface logic 310 may also allow a user to associate a party's name or identifier with a program that is to be recorded. For example, user interface logic 310 may prompt the user to provide an indicator identifying the party requesting the recording after the user enters a title/name via GUI 540. For example, after entering a name/title for a program that is to be recorded, user interface logic 310 may prompt the user to enter his/her name. As an example, if Joe is using user device 140 to record a television sitcom, Joe may enter “Joe,” or some other identifier (e.g., Dad) after entering the user-supplied name/title that will be associated with the show in listing 590.

In such instances, when a user later access the recorded programs by selecting recorded programs item 526 (FIG. 5A), the programs listed in menu 590 may be annotated with an indicator that Joe stored the program. Still further, in some implementations, the programs listed in menu 590 may be grouped based on the party that initiated or requested the recording. For example, all of the programs recorded by Joe may be listed together under a heading “Joe's recording.” Similarly, each other party recording programs on communication device 110 may have his/her list of recorded programs under a heading associated with that party (e.g., “Mom's recordings, “Jake's recordings,” etc.). In this manner, user interface logic 310 may output a recorded program list in a manner that allows a user to quickly find his/her programs of interest.

In addition, in some implementations, user interface logic 310 may allow a user to associate an importance indicator with one or more programs that are to be recorded. For example, user interface logic 310 may prompt the user to provide an importance measure or indication associated with a program after the user enters a title/name via GUI 540. In other instances, GUI 540 may include an “importance” or “rating” icon/item that allows a user to input an importance rating from, for example, 1-5, where a 1 represents the highest importance and a 5 represents the lowest importance.

In such instances, when a user later accesses the recorded programs by selecting recorded programs item 526 (FIG. 5A), the programs listed in menu 590 may be provided in an order based on the user-supplied importance information. For example, the most important program may be listed first, followed by the next most important program, etc. In still other instances, the programs listed in menu 590 may be illustrated using different colors to indicate relative importance. For example, important programs may be displayed in red, less important programs may be displayed in yellow and least important programs may be displayed in green. In still other instances, programs defined as most important may be indicated in other ways, such as using a larger font, via flashing on/off of the name/title, offset via stars or asterisks, etc. In each case, an importance factor may be used to further facilitate retrieval of recorded programming. In this manner, a user may be able to quickly ascertain what has been recorded, as well as in some instances, ascertain the importance level associated with each recorded program.

In some implementations, communication device 110 may use the importance measures when deleting items stored by communication device 110. For example, if memory 230 in communication device 110 is full and communication device 110 is in the process of recording a new program, communication device 110 may automatically delete a program identified as least important to make memory space available for the new recording.

In addition, in some implementations, user interface logic 310 may allow a user to provide various icons or symbols associated with a recording. For example, user interface logic 310 may display a number of emoticons or other symbols via GUI 540 that convey a category associated with programming. These categories may include comedy, drama, horror, sports-related, etc. The user requesting the recording may select or assign an appropriate emoticon/icon that indicates the category of the program that is to be recorded. In other instances, icons representing various parties in a household that use communication device 110 (e.g., Mom, Dad, Jake, Susan, etc.) may be provided on GUI 540 that allow a user to select the particular icon when requesting a recording. In each case, menu 590 may display the emoticon/icon selected by the user when the user accesses the recorded program listing.

In this manner, various user-selected information may be used to supplement a user-defined name/title for a recorded program. This may allow a user to quickly obtain information of interest when viewing listing 590.

As also described above, recording interface program 300 may include speech recognition logic 340. In some instances, the user may voice commands or instructions to communication device 110 to record programs and provide user-defined names/titles and/or other information, as described above. In such implementations, speech recognition logic 340 may identify the voice command to record a particular program, identify the user-defined name/title to associate with the program and/or identify other supplemental information voiced by the user (e.g., the party recording the program, the program category, an importance measure, etc.). Speech recognition logic 340 may convert the voice information into text and store the recorded program information in the manner described above.

As described above, recording interface program 300 may be used to facilitate storage and later retrieval of recorded programs. In some implementations, user interface logic 310 may also allow a user to edit or annotate a name/title associated with a previously recorded show. For example, suppose that the user has recorded a basketball game that lasts 2 hours and 30 minutes. Further assume that a particularly good play (e.g., a dunk) occurs at 1 hour, 31 minutes into the recording. In this case, user interface logic 310 may allow the user to edit or annotate the previously supplied title to indicate the time of the good play. For example, the user may annotate the title “Cavaliers game,” with the subtitle or additional information “dunk at 1:31,” or some similar indicator. This may allow the user to easily find the location of interest at a later time.

As another example, assume that a user (e.g., Anne) has recorded a program in which he/she appeared (e.g., a local news program). In this case, the user may add information to the previously supplied title “local news,” such as “Anne at 0:14,” to indicate the time in the program that the user appeared. This will allow the user to easily find the location of interest when replaying the recorded program for friends.

In other implementations, program names may be changed subsequent to the recording of the program to facilitate later retrieval. For example, a particular good episode of a weekly cop show may be modified from “CSI” to “CSI—great show.” In this manner, the user may be able to more easily track shows that he/she may wish to watch multiple times.

Implementations described herein allow users to provide names/titles and/or other information for programming that is to be recorded. This may facilitate use of a recording device and also enhance a user's enjoyment with respect to recording and watching programming from a service provider.

The foregoing description of exemplary implementations provides illustration and description, but is not intended to be exhaustive or to limit the embodiments to the precise form disclosed. Modifications and variations are possible in light of the above teachings or may be acquired from practice of the embodiments.

For example, in the implementations described above, a user was prompted to provide a user-defined name/title for a program that is to be recorded. In some implementations, user interface logic 310 may pre-populate the user-defined name with the name from the programming guide provided by service provider 130. The user may then modify or change the name to a more appropriate name based on the user's particular preference. However, pre-populating the name with a programming guide may allow the user to more quickly enter the information of choice.

In addition, features have been described above as allowing a user to enter user-supplied information associated with a manual recording mode. Similar user-supplied information may be input by a user when operating in other recording modes, such as when instructing communication device 110 to record an entire series of shows. For example, a user may select series manager item 524 in menu 520 and provide user-supplied names/titles and/or other information associated with recording the series of programs.

Still further, features have been described above mainly with respect to user device 140 being a remote control device. However, as discussed above, in some implementations, user device 140 may be a PC, laptop, mobile terminal (e.g., cellular telephone). In each case, user device 140 may be used to input user-defined, customized information that will be associated with recorded programs.

In addition, while series of acts have been described with respect to FIG. 4, the order of the acts may be varied in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
receiving, at a recording device, an instruction or command from a user to record television programming on a first channel for a period of time;
receiving, at the recording device, information from the user, the information identifying one or more names or titles to associate with the programming to be recorded on the first channel for the period of time;
recording the programming on the first channel for the period of time;
receiving, at the recording device, a request to view a list of recorded programs, the list including the programming recorded on the first channel for the period of time; and
outputting, by the recording device, the list of the recorded programs, the list including the one or more names or titles associated with the programming on the first channel for the period of time.

2. The method of claim 1, wherein the one or more names or titles is not the same as information provided in a television programming guide, the method further comprising:
prompting the user to provide a name or title with the programming to be recorded on the first channel for the period of time.

3. The method of claim 1, wherein the period of time includes a duration that spans at least two television shows, wherein the receiving information from the user comprises:
receiving information from the user that separately identifies each of the at least two television shows, and wherein the outputting the list of recorded programs comprises:
outputting the information identifying each of the at least two television shows.

4. The method of claim 1, further comprising:
prompting the user to identify a party associated with recorded television programming; and
receiving information from the user identifying the party associated with the television programming on the first channel for the period of time, wherein the outputting the list comprises:
outputting the information identifying the party associated with the television programming recorded on the first channel for the period of time.

5. The method of claim 4, wherein the outputting the list of recorded programs further comprises:
grouping items in the list of recorded programs based on the parties that recorded the programs.

6. The method of claim 1, further comprising:
selecting, by the user, a first icon associated with the television programming on the first channel for the period of time, the first icon being selected from a plurality of icons, wherein the outputting the list further comprises:
outputting the first icon with the one or more names or titles.

7. The method of claim 6, wherein the first icon represents a party associated with the programming to be recorded or a category associated with the programming to be recorded.

8. The method of claim 1, further comprising:
prompting the user to identify an importance measure associated with the programming on the first channel for the period of time; and
receiving the importance measure from the user.

9. The method of claim 8, wherein the outputting the list further comprises:
displaying the importance measure associated with the television programming on the first channel for the period of time.

10. The method of claim 8, wherein the outputting the list further comprises:
ordering items in the list of recorded programs based on importance measures provided by the user.

11. The method of claim 1, further comprising:
receiving, from the user, an addition or modification to a programming description provided in a programming guide for a second program to be recorded; and
displaying the addition or modification with the list of recorded programs.

12. The method of claim 1, further comprising:
receiving, from the user, information identifying a location or time in at least one of the programs identified in the list of recorded programs, the location or time being associated with an item of interest in the at least one program.

13. A device, comprising:
a communication interface configured to receive programming from a service provider; and
logic configured to:
receive an instruction or command from a user to record first programming, the first programming corresponding to programming on a first channel for a first period of time,
receive user-provided information to associate with the first programming,
record the first programming,
receive a request to view programs recorded by the device, and
output a list of programs recorded by the device, the list of programs including the user-provided information associated with the first programming.

14. The device of claim 13, wherein the first programming includes at least two television programs, wherein when receiving user-provided information, the logic is configured to:
receive information from the user separately identifying each of the at least two television programs, and when outputting the list of recorded programs, the logic is configured to:
output the information identifying each of the at least two television programs.

15. The device of claim 13, wherein the logic is configured to:
prompt the user to identify a party associated with the first programming, and
receive information from the user identifying the party associated with the first programming, and when the outputting the list, the logic is configured to:
output the information identifying the party associated with the first programming.

16. The device of claim 13, wherein the logic is further configured to:
group or order items in the list of recorded programs based on user-provided information associated with the items in the list of recorded programs.

17. The device of claim 13, wherein when receiving user-provided information, the logic is configured to receive the user-provided information via voice communications from the user, wherein the logic is further configured to:
perform speech recognition on the voice communications from the user.

18. The device of claim 13, wherein the device comprises a set top box.

19. A computer-readable medium having stored thereon sequences of instructions which, when executed by at least one processor, cause the at least one processor to:
receive an instruction or command from a user to record first programming, the first programming corresponding to programming on a first channel for a first period of time;
receive user-provided information to associate with the first programming;
receive a request to view programs recorded by the device, and
output a list of programs recorded by the device, the list of programs including the user-provided information associated with the first programming.

20. The computer-readable medium of claim 19, further including instructions for causing the at least one processor to:
provide a user interface to a display device, the user interface including an item to prompt the user to provide a name or title with the first programming.
